(19) United States
(12) Patent Application Publication
(10) Pub. No.: US 2025/0291830 A1
(43) Pub. Date: Sep. 18, 2025

(54) SYSTEM AND METHOD FOR GENERATING RECORD SUMMARIES USING ARTIFICIAL INTELLIGENCE

(71) Applicant: HSI USA Holding, Inc., Frisco, TX (US)

(72) Inventors: Jose Manuel William Arcilla, McKinney, TX (US); Michael Alan Case, Kennewick, WA (US); John William Hambelton, Eugene, OR (US)

(21) Appl. No.: 19/077,806

(22) Filed: Mar. 12, 2025

Related U.S. Application Data
(60) Provisional application No. 63/564,294, filed on Mar. 12, 2024.
(60) Provisional application No. 63/564,784, filed on Mar. 13, 2024.
(60) Provisional application No. 63/565,901, filed on Mar. 15, 2024.
(60) Provisional application No. 63/566,640, filed on Mar. 18, 2024.
(60) Provisional application No. 63/663,991, filed on Jun. 25, 2024.
(60) Provisional application No. 63/663,994, filed on Jun. 25, 2024.
(60) Provisional application No. 63/663,999, filed on Jun. 25, 2024.
(60) Provisional application No. 63/664,004, filed on Jun. 25, 2024.

(51) Int. Cl. G06F 16/34; G06F 21/31; G06F 21/62

(52) U.S. Cl. CPC G06F 16/345; G06F 21/31; G06F 21/62; G06F 2221/2113

(57) ABSTRACT

Systems, methods, and computer-readable storage media for Artificial Intelligence (AI) data summarization A system can receive having multiple fields and a request from a user for a summarization of the record. The system can also receive an authorization level of the user and redact a portion of the record based on the authorization level, resulting in a modified copy of the record. The system can then generate, via an Artificial Intelligence (AI) algorithm, a summary of the modified copy of the record.

### CROSS-REFERENCE TO RELATED APPLICATIONS

The instant application is a U.S. Non-Provisional application that claims priority to U.S. Provisional Application No. 63/564,294 filed Mar. 12, 2024, U.S. Provisional Application No. 63/564,784 filed Mar. 13, 2024, U.S. Provisional Application No. 63/565,901 filed Mar. 15, 2024, U.S. Provisional Application No. 63/566,640 filed Mar. 18, 2024, U.S. Provisional Application No. 63/663,994 filed Jun. 25, 2024, U.S. Provisional Application No. 63/663,991 filed Jun. 25, 2024, U.S. Provisional Application No. 63/663,999 filed Jun. 25, 2024 and U.S. Provisional Application No. 63/664,004 filed Jun. 25, 2024, the entire contents of each of which are hereby incorporated by reference in their entireties.

The present application is related to co-pending U.S. application Ser. No. ______, Attorney Docket No. 131637.607931, filed Mar. 12, 2025, U.S. application Ser. No. ______, Attorney Docket No. 131637.607935, filed Mar. 12, 2025, and U.S. application Ser. No. ______, Attorney Docket No. 131637.605724, filed Mar. 12, 2025, the entire contents of each of which are hereby incorporated by reference in their entireties.

### BACKGROUND

### 1. Technical Field

The present disclosure relates to Artificial Intelligence (AI) data summarization, and more specifically to summarizing data records using AI.

### 2. Introduction

Large, complex set of records can contain hundreds of fields per record type, and may also contain relationships to other record types which make the record difficult to understand by itself. Such records are difficult to consume and take considerable time to comprehend the important contents.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a record comprising a plurality of fields; receiving, at the computer system from a user, a request for a summarization of the record; receiving, at the computer system, an authorization level of the user; redacting, via at least one processor, a portion of the record based on the authorization level, resulting in a modified copy of the record; and generating, via an Artificial Intelligence (AI) algorithm, a summary of the modified copy of the record.

A system configured to perform the concepts disclosed herein can include: at least one processor; and a non-transitory computer-readable storage medium having instructions stored which, when executed by the at least one processor, cause the at least one processor to perform operations comprising: receiving a record comprising a plurality of fields; receiving, from a user, a request for a summarization of the record; receiving an authorization level of the user; redacting a portion of the record based on the authorization level, resulting in a modified copy of the record; and generating, via an Artificial Intelligence (AI) algorithm, a summary of the modified copy of the record.

A non-transitory computer-readable storage medium configured as disclosed herein can have instructions stored which, when executed by at least one processor, cause the at least one processor to perform operations which include: receiving a record comprising a plurality of fields; receiving, from a user, a request for a summarization of the record; receiving an authorization level of the user; redacting a portion of the record based on the authorization level, resulting in a modified copy of the record; and generating, via an Artificial Intelligence (AI) algorithm, a summary of the modified copy of the record.

### BRIEF DESCRIPTION OF THE DRAWINGS

FIG. 1 illustrates an example of a process workflow;

FIG. 2 illustrates an example of AI summary generation;

FIG. 3 illustrates an example method embodiment; and

FIG. 4 illustrates an example computer system.

### DETAILED DESCRIPTION

Various embodiments of the disclosure are described in detail below. While specific implementations are described, this is done for illustration purposes only. Other components and configurations may be used without parting from the spirit and scope of the disclosure.

When filling out a form, by definition an individual is putting down various facts and information into predefined fields. Sometimes those fields are structured, meaning that the data being put into those fields have a standardized format for efficient access by software and humans alike. Other times those fields are unstructured, allowing the individuals filling out the form can use prose or other combinations of text to convey the sought after information.

A data collection platform can be used to receive, store, and analyze such records. Any type of records which can be defined in low/no-code forms and workflow engine can be compatible with the disclosed system. For some types of record collection (such as Environmental, Health, Safety, and Quality (EHSQ) records, college application records, employee records), there may be compliance and/or risk management need of an organization in receiving, storing, processing, and analyzing the records. Another non-limiting example can include project management, where records represent bugs, product features, and releases. Because the context of the system is configurable, the outputs of the system (such as analysis of the records) can be combined with other strings of AI outputs if desired (such as recommendations based on the records, rather than pure summarization/analysis of the records). Non-limiting examples of the data these records contain can include incidents, audits, contractor management, checklists, inspections, observations, asset management, name, social security number, age, financial situation, address, and many others. Each of these record types contains their own set of data unique to their purpose. The data collection platform can be configured to identify within each record type the data types (text, date, checkbox, etc.) of the fields being recorded.

Because this large, complex set of records can contain hundreds of fields per record type and may also contain relationships to other record types which make the record even more complex, these records can be difficult to consume and take considerable time to comprehend the important contents.

Systems configured as disclosed herein can create AI generated summaries of these records, resulting in an effective and straightforward way for individuals to consume a summary of this content. Using an AI algorithm deploying a Large Language Model (LLM), the AI algorithm can be provided with the entire dataset of the record (or a specific portion thereof). The LLM itself can be a conventional, off the shelf product. Alternatively, the LLM can be tailored/trained specifically on data associated with a particular field of use associated with the records being analyzed. The record may be configured to place emphasis on particular data points or related records to guide the AI to summarize the most important aspects of the record. The system can know which points to emphasize based on a per-record context, such that the points of emphasis for each record varies according to that context. That is, once the system identifies the context of a given record, it can identify words, events, data, or other aspects within the record and emphasize those most related to the overall record context. Likewise, the system can use the same mechanism to identify data not related to the context, and therefore not used in the generated summary. The user's role can also be provided to improve the AI summary's context for the reader, and potentially hide sensitive information not accessible to certain roles. For example, if the user is the user is the boss/authority over those listed in the record being summarized, then the user may have access to information which would otherwise be redacted or unavailable. The result is a concise summary, easily consumed by the end user. In some configurations, the summary can be in a natural language format, as produced by an LLM. In other configurations, the summary can be in a numerical or statistical format. In yet other configurations, the summary can have bullet points summarizing specific points of the record. Still other configurations can use a combination of one or more types of summarizations (e.g., a mix of natural language, statistics, and bullet points). In one example configuration, the summary generated is a natural language paragraph of four to five sentences, from which an optional bulleted list can be generated. The output format can be part of the dynamic context of the record. Because some record types (incidents, for example) are best communicated in paragraph form, based on a record type a paragraph output may be selected. Other record types in the system can be given completely different context (i.e., not incidents) and aspects of the record, such as length, use of bulleted lists, emphasis on impacted individuals within the record, etc., can be used to identify the context of the record and the output format that would be best for a summarization of the record.

Summaries of records can be cached for instant retrieval when a record's state has not changed. The records can, for example, be cached in a different database and date stamped, which can save considerable processing for archived or unchanged records. For example, when requested, if the record has not been changed since the last cache, the cached response is provided (i.e., the same cached response that was previously generated). If the context of the record has been redefined, the system can then re-summarize the record. Preferably, the cache records are indexed based on the record IDs, such that it is fetching updated records is easily achieved. Cached summaries can be processed further to provide summarizations of multiple record sets (e.g., a summary of multiple records and/or a summary of summaries of records). When a record's state has changed (or been otherwise updated), the system can generate a new summary. Detection of those updates or changes can occur, for example, based on data identifying when a record was last updated and a corresponding summary generated, or by doing a comparison of a previous record to a current record.

Consider the following example. An enterprise has a record type called “incidents.” That record may have hundreds of fields (names of individuals involved, time, location, each person's accounting of the incident, the follow up, etc.) with hundreds of individual data points. That incident record may have relationships to other records within the system (e.g., a human resources file on each individual listed in the incident record, times a similar incident has occurred, etc.). In this manner, an incident record may contain all the information that happened during the incident and then it has relations to the people involved, the assets involved, the locations, etc., resulting in a large web of information, such that each incident is its own highly dense record. However, this one record is a small component of an overall record program, meaning the system contains records of additional data such as (but not limited to) incident management audits, contract management, checklist management, checklists, personnel, etc. The system can identify, via a record schema to which the AI has access to, the schemas of record field values. These schemas of record field values can include any record interlinking relationships. For example, if an incident involves physical assets (e.g., vehicles or equipment) that are stored as related records, the record schema for the incident will identify that context. If working with Occupational Safety and Health requirements, there could be thousands of checklists right, non-limiting examples of which include daily forklift equipment inspections, daily PPE or personal protective equipment inspections, checklists, and or other data.

Every enterprise is unique in the type of data they record, and the way in which they record it, such that how each enterprise maintains records is different. Indeed, this can vary from building to building, group to group, making normalization of the data, much less summarization and drawing conclusions from the data, extremely complicated. Systems configured as disclosed herein can overcome these hurdles by identifying both re-record context and/or record field context (preferably both). In this manner the system can also determine not only what a record is about (i.e., the record context) based on data and metadata in the record (e.g., the title), but can also store what the record means in the real world and what it should mean to an LLM (e.g., a utility context of the record). This represents an advantage over both statically designed software and other form/automation/workflow systems, because unlike those systems, systems configured as disclosed herein can overcome the non-normalized data by allowing for dynamic context. The context only needs to be provided/determined once per record and/or record type, and that context is only modified if the record, record type, or definitions of contexts dramatically changes.

The system can identify for each individual user their role, title, or other designation within an enterprise and identify what data that individual user can consume. The resulting summaries produced by the system use those roles when providing the summary.

To generate the summary, the system first identifies the role/authorization of the individual requesting the summary, thereby determining if this individual is allowed to know about this record. Based on that level of authorization, the system can gather (or redact) appropriate information before beginning the AI summarization. Next, the system determines if the requesting individual has identified or otherwise configured any of these data points with particular emphasis for the AI summary. In some configurations, in addition to the context determinations for emphasis discussed above, the users/individuals can utilize a User Interface (UI) to identify points of emphasis. In such configurations, the points of emphasis a user wants to see may vary based on their job title, based on the point of investigation, etc. For example, if the requesting individual wants to know how an incident relates to another incident, or if there is a particular context through which the summary should be generated (e.g., an Engineering department may want a very different summary than a Human Resources department, and likewise the Legal summary may be very distinct from a marketing summary). Identifying of the data points that need particular emphasis can be done by flagging particular fields within the record. Alternatively, identification of the aspects that need emphasis can be done by including a particular instruction to the AI algorithm, such as “provide a Legal summary.” This is a configurable context. Because the system, records, and individual fields can each be given their own dynamic context, each record can have different emphasis (or de-emphasis).

Summaries can be provided to administrators and/or end users. This can be valuable as many records are very data-dense and data is hidden behind tabs, scrolling, etc. In addition to this, the summaries can be used as the starting point for other AI related features. For example, incident summaries can be provided to a training catalog AI for training recommendations. Another use case can be a holistic analysis of all summaries within the database of records, e.g. a “summary of summaries,” which provides an more efficient way of providing trends than processing all data points for all records.

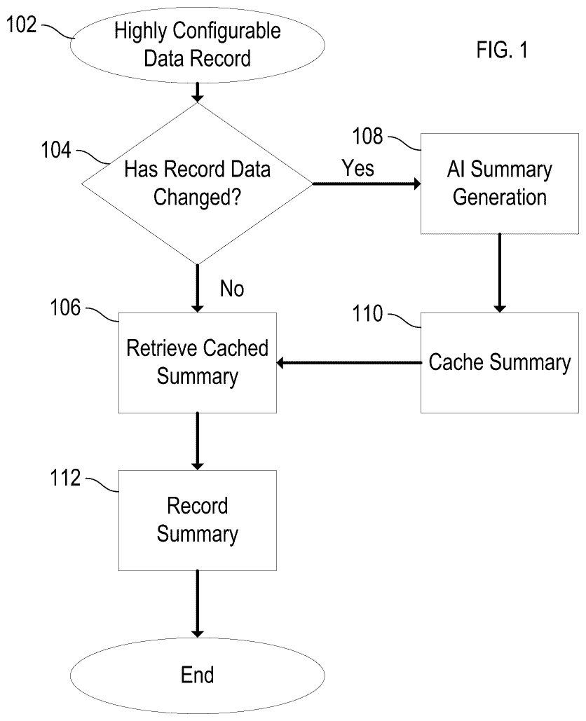

FIG. 1 illustrates an example of a process workflow. As illustrated, this system user can identify a highly configurable data record 102. In this example, the user is authorized to view all details about the highly configurable data record, whereas in other configurations portions of the highly configurable data record 102 may need to be redacted before continuing, or the user may be restricted from viewing aspects of the highly configurable data record 102.

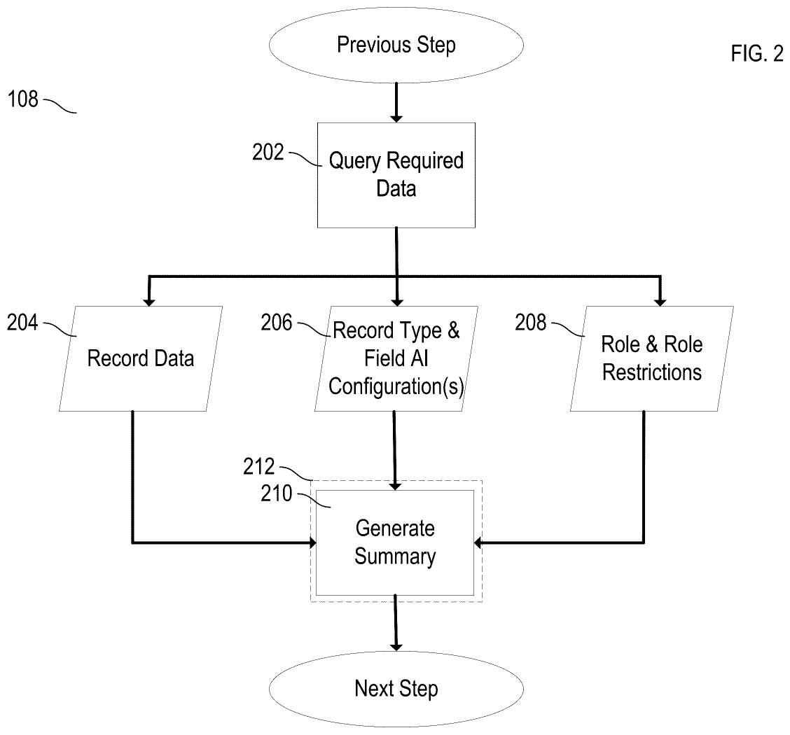

The system determines if the highly configurable data record 102 has changed 104 since a previous summarization occurred, or since the user previously viewed the summarization. If the highly configurable data record 102 has not changed then the system can retrieve a cached summary 106 (thereby saving time and processing). If the highly configurable data record 102 has changed since the last time this user has viewed it or if the highly configurable data record 102 has changed, the system generates an AI summary 108, discussed below with respect to FIG. 2. There are not thresholds associated with this, as the system does not know if the change invalidates the summary or not. The only time a summary is not triggered is when a field excluded from summary consideration is not updated. The system then stores that summary in a cache 110, and the record summary 112 (whether recently generated 108 or retrieved from a cache 106) can be provided to the user. Thus, the record can be loaded with or without the associated summary, and the summary can be generated without the record being loaded. If a record is loaded, the summary can be generated asynchronously and provided when it is ready. While as illustrated the record summary 112 is retrieved from the cache 106, in some configurations the AI summary generation 108 can directly deliver the record summary 112 to the user. In such configurations, the caching of the record summary 110 may be done in parallel with delivery of the record summary 112 to the user, or may otherwise be done separately from the delivery.

Preferably, the record summary 112 provided is a JavaScript Object Notation (JSON) object, though other formats are also possible. Upon receiving the record summary 112, the system confirms that all role considerations and role restrictions are applied, such that if a user has a restricted role, that user is not allowed to see confidential information. For example, the user may be able to see what happened in a given incident, but they can't see who it happened to (e.g., removing Personal Identifiable Information (PII)). Preferably such information is extracted out before the summary is generated (i.e., AI summary generation 108), however confirmation that the unauthorized information is not present can occur after the AI summary generation 108 is complete. If a previously generated record summary is cached, such that is could be retrieved 106, upon retrieving the cached summary 106 the system can confirm that the person who originally requested generation of the cached record summary and the person currently requesting the summary have the same roles and/or authorization. If not, an updated record summary 112 may be AI generated 108, or the existing/cached summary may be updated (e.g., to redact information, or to provide previously redacted information) before being provided to the new user. In this manner, the record summaries stored in the caches are tied to both user and role, so that users cannot see a cached version that may contain information that they are not authorized to sec.

FIG. 2 illustrates an example of AI summary generation. FIG. 2 is an expanded view of the AI summary generation 108 illustrated in FIG. 1. As illustrated, upon determining that the record has changed (or that no summary exists for a given record), the system generates a query for required data 202. This required data can include the record data 204 (e.g. information regarding the individuals, locations, and/or events cited in the record) for the record in question (or a portion thereof); the record type & field AI configuration(s) 206 (e.g., is this an EHSQ record, an application record, etc.); and role and role restriction 208 (e.g., authorization level) about the requesting user for the record summary. Using that information, the system can generate a summary 210 of the record in question, preferably using an Artificial Intelligence (AI) algorithm.

Consider the following example. An incident report is generated outlining: date and time of incident, location, employee information (e.g., name, title, age, experience), a description of the incident, injury sustained, witness statements, treatment delivered, a root cause analysis, corrective actions taken, and information about the individual that prepare the report. Note that these individual record fields may vary based on circumstance, record type, etc., and are given purely as an example. Likewise, note the data may be collected by a team across various investigation steps spanning days, weeks, or months.

Example output from the AI summarization system disclosed herein can include a short summary in narrative format: On Feb. 28, 2025, at 10:15 AM, John Doe, a 34-year-old warehouse associate with 5 years of experience, fell from a ladder while retrieving inventory in Warehouse A, Pasco, WA. The ladder slipped, causing John to fall approximately 8 feet to the concrete floor. He sustained a fractured right wrist, a sprained left ankle, and minor cuts and bruises. Immediate first aid was administered, and John was transported to the hospital for further treatment, including a cast for his wrist and pain medication. Witness Kaitlyn Smith reported that the ladder was not properly secured. The root cause was identified as improper ladder usage, with no spotter present. Corrective actions include mandatory ladder safety training, new ladders with non-slip feet, a policy requiring spotters for tasks involving ladders over 6 feet, and regular ladder inspections. Report prepared by Jane Smith, Safety Officer, on Feb. 28, 2025.

In some configurations, the AI algorithm can use a LLM operated by a third party 212. For example, the system may configure or otherwise prepare/redact/format the record data 204, record type & field AI configuration(s) 206, and role & restrictions, then send all of that to a third party 212 LLM with a prompt such as “generate a five sentence summary of the following materials.” The third party 212 can then generate a natural language summary of the record according to the instructions and data provided.

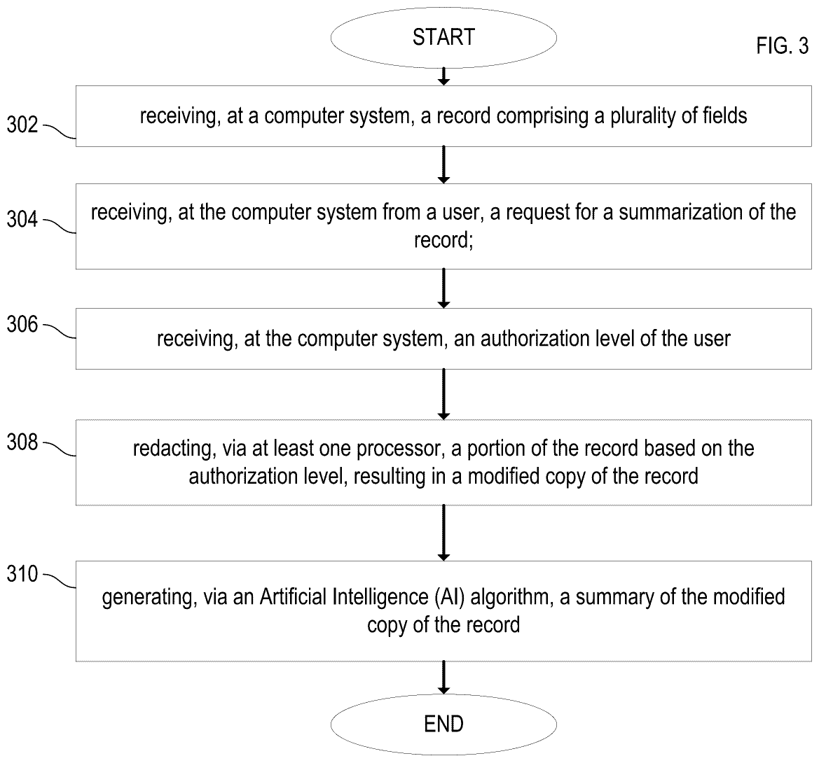

FIG. 3 illustrates an example method embodiment. As illustrated, the method can include receiving, at a computer system, a record comprising a plurality of fields (302) and receiving, at the computer system from a user, a request for a summarization of the record (304). The method can continue by receiving, at the computer system, an authorization level of the user (306) and redacting, via at least one processor, a portion of the record based on the authorization level, resulting in a modified copy of the record (308). Next, the method can include generating, via an Artificial Intelligence (AI) algorithm, a summary of the modified copy of the record (310).

In some configurations, the plurality of fields can include: at least one structured data field; and at least one unstructured data field.

In some configurations, least one field in the plurality of fields can be identified as having an emphasis.

In some configurations, the AI algorithm can use a Large Language Model (LLM) to generate the summary.

In some configurations, the illustrated method can further include: after generating the summary, storing the summary in a cache. In such configurations, the method can further include verifying, via the at least one processor prior to the generating of the summary, that the cache does not contain the summary of the modified copy of the record.

In some configurations, the record can be associated with an incident, the incident being one of an Environmental incident, a Health incident, and a Safety incident.

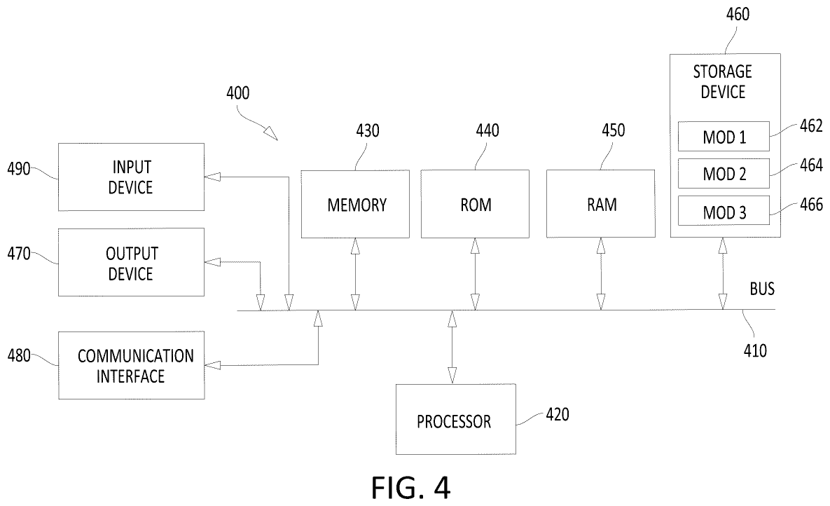

With reference to FIG. 4, an exemplary system includes a computing device 400 (such as a general-purpose computing device), including a processing unit (CPU or processor) 420 and a system bus 410 that couples various system components including the system memory 430 such as read-only memory (ROM) 440 and random access memory (RAM) 450 to the processor 420. The computing device 400 can include a cache of high-speed memory connected directly with, in close proximity to, or integrated as part of the processor 420. The computing device 400 copies data from the system memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The system memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general-purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in memory ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, system bus 410, output device 470 (such as a display or speaker), and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 400 is a small, handheld computing device, a desktop computer, or a computer server.

Although the exemplary embodiment described herein employs the storage device 460 (such as a hard disk), other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The technology discussed herein refers to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. For example, unless otherwise explicitly indicated, the steps of a process or method may be performed in an order other than the example embodiments discussed above. Likewise, unless otherwise indicated, various components may be omitted, substituted, or arranged in a configuration other than the example embodiments discussed above.

Further aspects of the present disclosure are provided by the subject matter of the following clauses.

A method comprising: receiving, at a computer system, a record comprising a plurality of fields; receiving, at the computer system from a user, a request for a summarization of the record; receiving, at the computer system, an authorization level of the user; redacting, via at least one processor, a portion of the record based on the authorization level, resulting in a modified copy of the record; and generating, via an Artificial Intelligence (AI) algorithm, a summary of the modified copy of the record.

The method of any preceding clause, wherein, the plurality of fields comprise: at least one structured data field; and at least one unstructured data field.

The method of any preceding clause, wherein at least one field in the plurality of fields is identified as having an emphasis.

The method of any preceding clause, wherein the AI algorithm uses a Large Language Model (LLM) to generate the summary.

The method of any preceding clause, further comprising: after generating the summary, storing the summary in a cache.

The method of claim 5, further comprising: verifying, via the at least one processor prior to the generating of the summary, that the cache does not contain the summary of the modified copy of the record.

The method of any preceding clause, wherein the record is associated with an incident, the incident being one of an Environmental incident, a Health incident, and a Safety incident.

A system comprising: at least one processor; and a non-transitory computer-readable storage medium having instructions stored which, when executed by the at least one processor, cause the at least one processor to perform operations comprising: receiving a record comprising a plurality of fields; receiving, from a user, a request for a summarization of the record; receiving an authorization level of the user; redacting a portion of the record based on the authorization level, resulting in a modified copy of the record; and generating, via an Artificial Intelligence (AI) algorithm, a summary of the modified copy of the record.

The system of any preceding clause, wherein, the plurality of fields comprise: at least one structured data field; and at least one unstructured data field.

The system of any preceding clause, wherein at least one field in the plurality of fields is identified as having an emphasis.

The system of any preceding clause, wherein the AI algorithm uses a Large Language Model (LLM) to generate the summary.

The system of any preceding clause, the non-transitory computer-readable storage medium having additional instructions stored which, when executed by the at least one processor, cause the at least one processor to perform operations comprising: after generating the summary, storing the summary in a cache.

The system of any preceding clause, the non-transitory computer-readable storage medium having additional instructions stored which, when executed by the at least one processor, cause the at least one processor to perform operations comprising: verifying, via the at least one processor prior to the generating of the summary, that the cache does not contain the summary of the modified copy of the record.

The system of any preceding clause, wherein the record is associated with an incident, the incident being one of an Environmental incident, a Health incident, and a Safety incident.

A non-transitory computer-readable storage medium having instructions stored which, when executed by at least one processor, cause the at least one processor to perform operations comprising: receiving a record comprising a plurality of fields; receiving, from a user, a request for a summarization of the record; receiving an authorization level of the user; redacting a portion of the record based on the authorization level, resulting in a modified copy of the record; and generating, via an Artificial Intelligence (AI) algorithm, a summary of the modified copy of the record.

The non-transitory computer-readable storage medium of any preceding clause, wherein, the plurality of fields comprise: at least one structured data field; and at least one unstructured data field.

The non-transitory computer-readable storage medium of any preceding clause, wherein at least one field in the plurality of fields is identified as having an emphasis.

The non-transitory computer-readable storage medium of any preceding clause, wherein the AI algorithm uses a Large Language Model (LLM) to generate the summary.

The non-transitory computer-readable storage medium of any preceding clause, the non-transitory computer-readable storage medium having additional instructions stored which, when executed by the at least one processor, cause the at least one processor to perform operations comprising: after generating the summary, storing the summary in a cache.

The non-transitory computer-readable storage medium of any preceding clause, the non-transitory computer-readable storage medium having additional instructions stored which, when executed by the at least one processor, cause the at least one processor to perform operations comprising: verifying, via the at least one processor prior to the generating of the summary, that the cache does not contain the summary of the modified copy of the record.

We claim:

1. A method comprising:
receiving, at a computer system, a record comprising a plurality of fields;
receiving, at the computer system from a user, a request for a summarization of the record;
receiving, at the computer system, an authorization level of the user;
redacting, via at least one processor, a portion of the record based on the authorization level, resulting in a modified copy of the record; and
generating, via an Artificial Intelligence (AI) algorithm, a summary of the modified copy of the record.

2. The method of claim 1, wherein, the plurality of fields comprise:
at least one structured data field; and
at least one unstructured data field.

3. The method of claim 1, wherein at least one field in the plurality of fields is identified as having an emphasis.

4. The method of claim 1, wherein the AI algorithm uses a Large Language Model (LLM) to generate the summary.

5. The method of claim 1, further comprising:
after generating the summary, storing the summary in a cache.

6. The method of claim 5, further comprising:
verifying, via the at least one processor prior to the generating of the summary, that the cache does not contain the summary of the modified copy of the record.

7. The method of claim 1, wherein the record is associated with an incident, the incident being one of an Environmental incident, a Health incident, and a Safety incident.

8. A system comprising:
at least one processor; and
a non-transitory computer-readable storage medium having instructions stored which, when executed by the at least one processor, cause the at least one processor to perform operations comprising:
receiving a record comprising a plurality of fields;
receiving, from a user, a request for a summarization of the record;
receiving an authorization level of the user;
redacting a portion of the record based on the authorization level, resulting in a modified copy of the record; and
generating, via an Artificial Intelligence (AI) algorithm, a summary of the modified copy of the record.

9. The system of claim 8, wherein, the plurality of fields comprise:
at least one structured data field; and
at least one unstructured data field.

10. The system of claim 8, wherein at least one field in the plurality of fields is identified as having an emphasis.

11. The system of claim 8, wherein the AI algorithm uses a Large Language Model (LLM) to generate the summary.

12. The system of claim 8, the non-transitory computer-readable storage medium having additional instructions stored which, when executed by the at least one processor, cause the at least one processor to perform operations comprising:
after generating the summary, storing the summary in a cache.

13. The system of claim 12, the non-transitory computer-readable storage medium having additional instructions stored which, when executed by the at least one processor, cause the at least one processor to perform operations comprising:
verifying, via the at least one processor prior to the generating of the summary, that the cache does not contain the summary of the modified copy of the record.

14. The system of claim 8, wherein the record is associated with an incident, the incident being one of an Environmental incident, a Health incident, and a Safety incident.

15. A non-transitory computer-readable storage medium having instructions stored which, when executed by at least one processor, cause the at least one processor to perform operations comprising:
receiving a record comprising a plurality of fields;
receiving, from a user, a request for a summarization of the record;
receiving an authorization level of the user;
redacting a portion of the record based on the authorization level, resulting in a modified copy of the record; and
generating, via an Artificial Intelligence (AI) algorithm, a summary of the modified copy of the record.

16. The non-transitory computer-readable storage medium of claim 15, wherein, the plurality of fields comprise:
at least one structured data field; and
at least one unstructured data field.

17. The non-transitory computer-readable storage medium of claim 15, wherein at least one field in the plurality of fields is identified as having an emphasis.

18. The non-transitory computer-readable storage medium of claim 15, wherein the AI algorithm uses a Large Language Model (LLM) to generate the summary.

19. The non-transitory computer-readable storage medium of claim 15, the non-transitory computer-readable storage medium having additional instructions stored which, when executed by the at least one processor, cause the at least one processor to perform operations comprising:
after generating the summary, storing the summary in a cache.

20. The non-transitory computer-readable storage medium of claim 19, the non-transitory computer-readable storage medium having additional instructions stored which, when executed by the at least one processor, cause the at least one processor to perform operations comprising:
verifying, via the at least one processor prior to the generating of the summary, that the cache does not contain the summary of the modified copy of the record.
